(19) United States
(12) Patent Application Publication
(10) Pub. No.: US 2017/0347397 A1
(43) Pub. Date: Nov. 30, 2017

(54) ROOFING HEATING SYSTEM

(71) Applicant: Floyd Moore, Fuquay Varina, NC (US)

(72) Inventor: Floyd Moore, Fuquay Varina, NC (US)

(21) Appl. No.: 15/604,572

(22) Filed: May 24, 2017

Related U.S. Application Data
(60) Provisional application No. 62/340,570, filed on May 24, 2016.

(51) Int. Cl. H05B 1/02

(52) U.S. Cl. CPC H05B 1/0288; H05B 2203/021; H05B 2214/02

(57) ABSTRACT

A roofing heating system that includes: a building; a roof, where the roof covers provides cover for the building; a series of heating elements within an interior surface of the roof; and connection wires, where the connection wires link the heating elements to a thermostat and a power source. The series of heating elements are preferably arranged in a series of rows and columns covering the inner surface of the roof. The heating elements enable heat transfer to an outer surface of the roof in order provide adequate temperatures to avoid accumulation of snow and ice on the outer surface of the roof.

### CROSS REFERENCE TO OTHER APPLICATIONS

This application claims priority to U.S. Provisional Application Ser. No. 62/340,570 filed on May 24, 2016.

### BACKGROUND OF THE INVENTION

### Field of Invention

The present invention relates to a heating system installed in a roof.

### Description of Related Art

Roofs have many issues to dealing with weather and durability. In particular, roofs must withstand rain, wind, snow and ice depending on location. Ice and snow can be particularly hazardous to a roofs condition. Snow can build up if heavy accumulation occurs. This snow buildup creates a weight problem for the roof and many times rooftops must be shoveled in order to avoid collapse, leaks or cracks. In addition snow and ice also can damage guttering and other related structures to the roof. As a result, it would be advantageous to have a system that could be used to provide adequate heat to the roof to avoid snow and ice accumulation.

### SUMMARY OF THE INVENTION

The present invention relates to a roofing heating system that includes: a building; a roof, where the roof covers provides cover for the building; a series of heating elements within an interior surface of the roof; and connection wires, where the connection wires link the heating elements to a thermostat and a power source. The series of heating elements are preferably arranged in a series of rows and columns covering the inner surface of the roof. The heating elements enable heat transfer to an outer surface of the roof in order provide adequate temperatures to avoid accumulation of snow and ice on the outer surface of the roof.

### BRIEF DESCRIPTION OF DRAWINGS

FIG. 1 depicts a roof defrost system according to the present invention.

### DETAILED DESCRIPTION

The present invention relates to a roof defrosting system that places heating elements within an interior surface of a roof aligned in a series of columns and rows. These heating elements are powered by a conventional connection to a power source within the building. A thermostat is provided to turn the heating elements on as necessary in order to provide adequate heat to avoid accumulation of snow and ice upon a roof.

The present invention relates to a roof heating system that is used to defrost and avoid accumulation of snow and ice on a roof. The present invention implements a series of heating elements aligned in a series of rows and columns connected to a thermostat. The heating elements are powered through an electrical power source of the building and distributed over an internal surface of the roof.

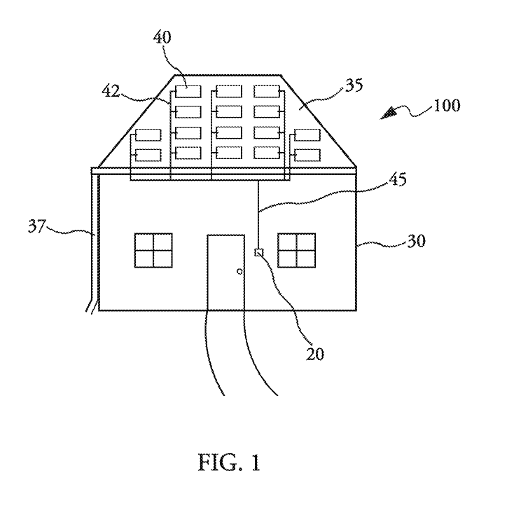

In reference to FIG. 1, a roof heating system according to the present invention as depicted the roof heating system 100 includes a series of heating elements 40 that are distributed on an internal surface of a roof 35 shown on top of a building 30. The heating elements 40 may be installed on the interior of roof 35 although depicted here on a residential building, this system may also be installed in a commercial building. The roof 35 shown in FIG. 1 is pitched, however the heating system 100 may also be installed on a flat roof. The connecting wiring 42 connects the heating elements 40 to a power source within the building and a thermostat 20. A thermostat connection 45 is shown connecting the wiring 42 to thermostat 20. The power source preferably is a circuit breaker within the building 30.

The thermostat 20 controls the heating temperature of heating elements 40. The heating elements 40 help to control an outer surface temperature of the roof 35. The heating elements 40 are preferably arranged in a series of rows and columns covering the inner surface of roof 35. This system enables the heating of the interior of the roof and as a result helps to avoid any accumulation of snow or ice on the roof. The system according to the present invention helps to avoid any problems with snow or ice accumulation. Also shown in FIG. 1 is a specialized gutter 37 that helps to ensure proper flow of moisture liquids from the melted snow. The instant invention has been shown and described in what it considers to be the most practical and preferred embodiments. It is recognized, however, that departures may be made there from within the scope of the invention and that obvious modifications will occur to a person skilled in the art.

What is claimed is:

1. A roofing heating system comprising:
a. a building;
b. a roof, where the roof covers provides cover for the building;
c. a series of heating elements within an interior surface of the roof; and
d. connection wires, where the connection wires link the heating elements to a thermostat and a power source.

2. The roof heating system according to claim 1, where the series of heating elements are arranged in a series of rows and columns.

3. The roof heating system according to claim 1, where the roof is pitched.
